(19) United States
(12) Patent Application Publication
(10) Pub. No.: US 2004/0003069 A1
(43) Pub. Date: Jan. 1, 2004

(54) Selective early drop method and system

(75) Inventor: David Wong, Campbell, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/183,637

(22) Filed: Jun. 28, 2002

(51) Int. Cl. G06F 15/173

(52) U.S. Cl. 709/223

(57) ABSTRACT

A network device includes at least a plurality of ports, a memory pool, and a service differentiation module. The plurality of ports is configured to send and receive data packets, and at least one port of the plurality of ports is connected to at least one network entity. The memory pool is configured to store the data packets. The service differentiation module is coupled with the memory pool, and is configured to regulate storage of the data packets in the memory pool based upon a comparison of terms negotiated between at least two network entities.

### BACKGROUND OF THE INVENTION

1. Field of the Invention

This invention relates to systems and methods for flow control within a digital communications network. In particular, this invention is related to systems and methods of performing service differentiation regarding the treatment of data packets within a network device.

2. Description of the Related Art

Over the last several years, the proliferation of the Internet has had a significant impact on many industries, especially the computer industry. The Internet has grown into an enormous network to which virtually any large or small computer network may be connected. In fact, it is now commonplace for the vast majority of people in industrialized nations to have access to the Internet, either through their business or work and/or through personal accounts. This connectivity has allowed many businesses, universities, governments, etc. to expand to provide their services via the Internet.

Most people or businesses receive their Internet access via an Internet Service Providers (ISPs). ISPs provision access to the Internet for their customers usually through membership subscriptions. ISPs make at least a portion of their income on service fees such as subscription fees, on-demand provisioning of services, etc. Accordingly, ISPs may offer various levels of service and often regulate the amount of Internet bandwidth (i.e., data speed) that a customer is entitled. Internet bandwidth may be sold in different amounts under service level agreements (SLAs). At the network level, SLAs are usually enforced via some sort of device configuration.

For example, one standard device configuration for controlling the data rate of network access involves controlling the data flow at a network device, such as a switch, between the Internet and World Wide Web (WWW) and a customer. A network device may be configured to use a rate control method such as the “leaky bucket.” The leaky bucket method involves configuring a network device to restrict the amount of data (i.e., data packets) that a customer may receive (e.g., via a port of the network device), by tokenizing the data and setting a threshold. Data packets are assigned a number of tokens by the device based on their size, and once a customer meets the threshold assigned for a period of time, all further packets are prevented from being switched or routed during that same period (i.e., buffered or dropped). The amount of data equal to a token and the amount of tokens a customer is afforded maybe set by the ISP. For example, a token may be considered to be 10 Kbits of data. A customer may be set to 200 tokens/second, or 2 Mbits/second (Mbps). Any data packets received to be routed to the customer which exceed this limitation must be buffered or dropped by the device.

Due to the rate control in the receiver, congestion may be caused by speed mismatches. Namely, when a burst of data is transmitted to a receiver, the receiver might not be able to process the incoming packets at the same speed as the sender transmits the packets. Therefore, the receiver may need to store the incoming packets in a buffer to temporarily hold the packets until the packets can be processed. However, since buffers are created to hold a finite amount of data, a buffer overflow, which may corrupt the current data stored in the buffer by overwriting the current data, may occur when the packets entering the buffer exceeds the buffer's capacity. To prevent a buffer overflow from occurring, a buffer manager may decide to drop the last few packets in the burst. The buffer manager must also make a service differentiation to determine which class or queue a packet should be dropped from when there is no available buffer space.

Where rate limiting or rate control is used to enforce SLA, data rate and line rate mismatch can cause network congestion which can lead to reduced performance and inefficient use of network bandwidth. Hence, the goal is to avoid congestion wherever possible by using conventional algorithms such as Random Early Detection (RED) or Early Random Drop (ERD) that capitalize on the adaptive nature of TCP traffic to use packet drops as a means of reducing the rate of TCP transmission. RED and ERD use a method to drop the packets from the incoming queues, in proportion to the bandwidth which is being used by each subscriber. However, if a network includes multiple TCP sources, then dropping packets uniformly from all sources causes all of the sources to back off and then begin retransmission all at once. This scenario leads to waves of congestion, also referred to as “global synchronization.” This situation causes drastic drops in throughput.

Rate controlling packet flow in a data network raises other flow control issues. For example, FIGS. 1A and 1B show a block diagram of a simple network configuration and packet flow related thereto. A network may contain a switch 106 or other network device, connected to clients 102 (subscriber A) and 104 (subscriber B). In a perfect system, the link speeds for each client connected to the device are matched, and the loads are spaced evenly. Here, data is flowing into switch 106 at a rate of 100 Mbps, and data is flowing to each subscriber A 102 and subscriber B 104 at a rate of 50 Mbps. If the packets are scheduled for each client alternatingly, as showing in FIG. 1B, then there are no flow control issues. However, if there is a burst to one client or the other, then a buffer would be required to store data since data is flowing to each subscriber A 102 and subscriber B 104 at half the rate that data is flowing into switch 106.

A severe mismatch is shown in FIGS. 2A and 2B. In this scenario, subscriber B 104 is allocated only 10 Mbps of bandwidth. If data packets are received and scheduled as shown in FIG. 2B, a very large (and expensive) buffer is required because of the speed mismatch. Assuming that a buffer is provided that can store five data packets, the sixth data packet intended for subscriber A 102 must be dropped because of the congestion. This is an undesired result since subscriber A most likely pays for more bandwidth than subscriber B.

Accordingly, new and improved systems and methods for service differentiation control are needed. Such systems and methods should decide based upon the policy terms agreed upon between a client and a ISP the quality of service provided to a subscriber.

### SUMMARY OF THE INVENTION

According to an embodiment of the invention, provided is a network device. The network device includes at least a plurality of ports, a memory pool, and a service differentiation module. The plurality of ports is configured to send and receive data packets, and at least one port of the plurality of ports is connected to at least one network entity. The memory pool is configured to store the data packets. The service differentiation module is coupled with the memory pool, and is configured to regulate storage of the data packets in the memory pool based upon a comparison of terms negotiated between at least two network entities.

According to another embodiment of the invention, provided is a method of flow control in a network device. The method includes a step of providing a plurality of ports in a network device. At least one port of the plurality of ports is connected to at least one network entity. The method also includes a step of receiving a data packet at one port of the plurality of ports. The method further provides a step of regulating storage of the packet in a memory buffer based upon terms negotiated between at least two network entities.

According to another embodiment of the invention, provided is a network device. The network device includes a plurality of ports, a memory pools means, and a service differentiation means. The plurality of ports is configured to send and receive data packets, and at least one port of the plurality of ports is connected to at least one network entity connected to the network device. The memory pool means is for storing data packets. The service differentiation means is for regulating storage of the data packet in a memory buffer based upon terms negotiated between at least two network entities.

### BRIEF DESCRIPTION OF THE DRAWINGS

The objects and features of the invention will be more readily understood with reference to the following description and the attached drawings, wherein:

FIG. 1A is a block diagram of a partial network;

FIG. 1B is a graph of packet flow in the partial network of FIG. 1A;

FIG. 2A is a block diagram of a partial network;

FIG. 2B is a graph of packet flow in the partial network of FIG. 2A;

FIG. 3 is a block diagram of an exemplary network according to an embodiment of the present invention;

FIG. 4 is block diagram of an exemplary network device according to an embodiment of the present invention;

FIG. 5 is a block diagram of an exemplary network according to an embodiment of the present invention;

FIG. 6 if a block diagram of an exemplary device which may support rate control and selective early drop according to an embodiment of the present invention;

FIG. 7A is a block diagram of a partial network;

FIG. 7B is a graph of packet flow in the partial network of FIG. 8A according to an embodiment of the present invention; and

FIG. 8 is a flowchart of a method for selective early drop according to an embodiment of the present invention.

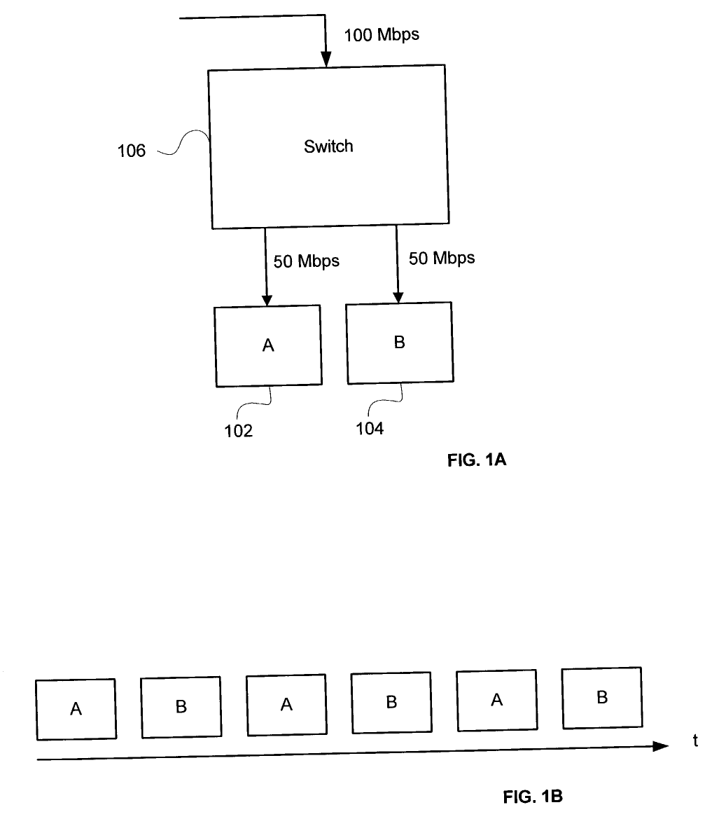

### DETAILED DESCRIPTION OF THE PREFERRED EMBODIMENTS

The present invention allows for a class-based selected discard of data packets and provides differentiated drop thresholds for premium versus standard traffic. In other words, a switch or other network device may drop packets based on customer priority. This scenario in effect allows system administrators to differentiate the type of service its clients receive by deciding which class, queue or port a packet should be dropped from based on the policy terms negotiated between the entities connected to the network.

For the purposes of the following discussion, the terms packet, data packet, traffic, and frame may be used interchangeably. According to a preferred embodiment of the present invention, the network device may be an Ethernet switch, and accordingly, a packet may refer to an Ethernet frame as defined by IEEE 802.x and as modified herein. Other devices and packets may also be within the scope of the invention.

Before network traffic (data packets) can receive differentiated treatment, the traffic may be first classified and “marked” in a way that indicates that these specific packets warrant different treatment than other packets. Typically, such different treatment can refer to priority of handling. In the Ethernet switch environment, packets may be prioritized by a priority tag. For example, an Ethernet data packet typically includes a preamble, destination address (DA), source address (SA), tag control information, VLAN, MAC type, and data fields. The tag control information may include a 3-bit priority field, a 1-bit canonical formation indicator (CFI), and a 12-bit VLAN tag or VLAN ID.

Packets may be routinely tagged when routed by a network device. For packets that are untagged, a method or apparatus according to the present invention may be configured to classify packets based on several different criteria and subsequently mark those packets using the bits of information in the tag VLAN field of an Ethernet frame. For example, the present invention may be configured to classify and switch packets based on the Type-of-service (ToS) field of the IP header. A network operator may define a plurality of classes of service using the bits in the ToS field in the IP header or priority bits in the Ethernet header. Then it is possible to utilize other Quality-of-service (QoS) features to assign appropriate traffic-handling policies, including congestion management, bandwidth allocation, and delay bounds for each traffic class.

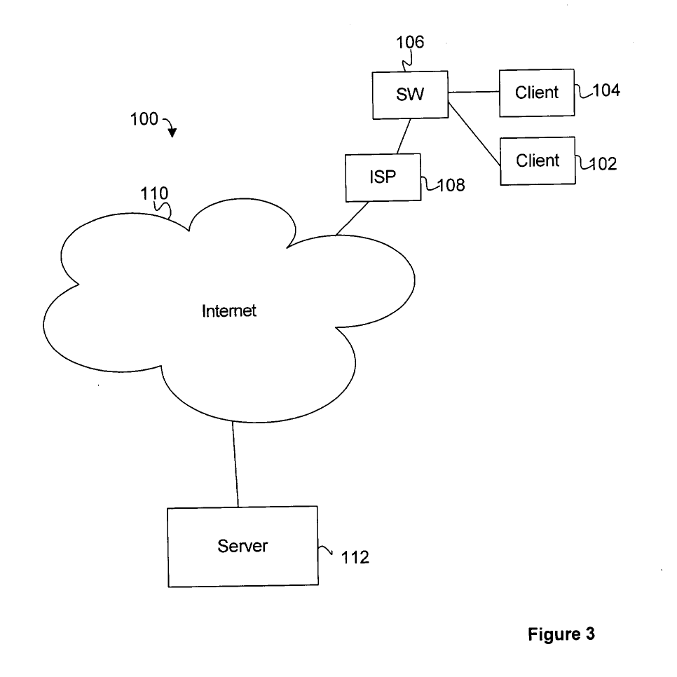

FIG. 3 is a block diagram of a network including a network device supporting a policy based selective early drop scheme in accordance with an embodiment of the present invention. Network 100 may utilize the Internet and World Wide Web. An ISP 108 (shown as a single device, but may include a plurality of servers or form an entire network) is connected to the Internet 110 and may provide Internet service to clients 104 and 102 via an Ethernet link. Clients 102 and 104 may be connected to a switch 106 configured and/or controlled by ISP 108. Internet content is provided to clients 102 and 104 via switch 106. Switch 106 may be the last network device between clients 102 and 104, and the Internet; or, intermediate devices may be between the client and the switch, such as a central office (CO), hub, routes, etc.

In a typical configuration, ISP 108 may provide a designated amount of bandwidth to subscriber A 102 and a different amount of bandwidth to subscriber B 104, according to service level agreements (SLA). This bandwidth may be regulated at switch 106 via built-in rate control. One standard method of rate control is the “leaky bucket” method. According to the “leaky bucket” method, subscriber A 102 may connect to a content server 112 and download some content. Switch 106, being the last device between the client and the ISP network/Internet, controls the bandwidth available for subscriber A 102. Switch 106 may assign a number of tokens to each data packet frame, etc. destined for subscriber A 102 (i.e., to the port connected to the client). The bandwidth may be regulated in terms of the number of tokens subscriber A 102 is allowed to receive over a period of time, and the number of tokens associated to the size of the packet. When subscriber A 102 meets its token threshold, the rest of the packets routed to subscriber A 102 are buffered, and then dropped by switch 106 according to flow control, which is described in more detail below. In this manner, the bandwidth of subscriber A 102 may be regulated by switch 106. However, to cure the deficiencies in the prior art, the system and method of service differentiation is modified as described below.

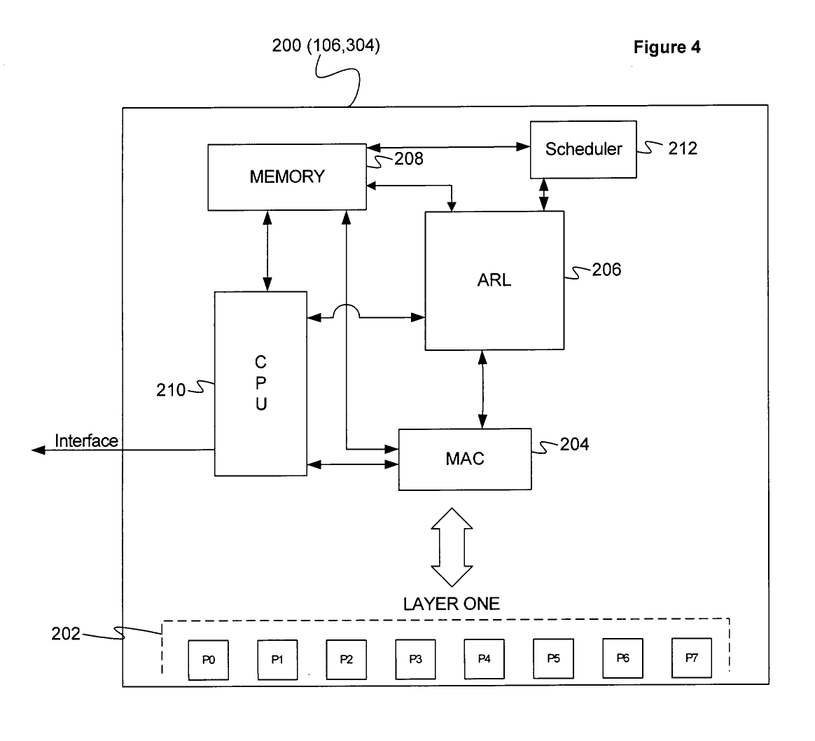

FIG. 4 is a block diagram of an exemplary network device according to an embodiment of the present invention. Device 200 may be, but is not limited to, a network switch, which may be implemented as switch 106 or 304 (described below), and may be used within a network to control the flow of data to a customer or subscriber. Device 200 may include a number of network ports 202 (e.g., P0-P7), which may be well known PHYs or transceivers and perform Ethernet layer one functions. Network ports 202 are connected to network devices on one end, such as subscriber A 102, and to media access controller (MAC) 204 internally via an interface layer (not shown). MAC 204 represents an Ethernet layer-two system which interfaces the layer one systems with the upper layers of the device. MAC 204 may perform standard layer two functions in addition to those described herein.

Device 200 may also include or be connected to a CPU 210 which may perform certain network functions, and which may communicate with, configure, and control other systems and subsystems of device 200. Device 200 may include memory 208, which may be any number of registers, SRAM, DRAM or other memory as necessary to perform networking functions. Also, device 200 may include Address Resolution Logic (ARL) 206 for performing networking functions, such as rate control, fast filter processing (FFP), congestion control, routing, learning, etc. Accordingly, ARL 206 is connected to and may communicate with MAC 204, CPU 210 and memory 208. ARL 206 may also be configured to pre-read (“snoop”) network ports 202 in order to perform or support a service differentiation scheme according to the present invention. Device 200 may include a scheduler 212, which may be part of memory pool 208 or ARL 206, or may be a separate subsystem. Scheduler 212 is configured to schedule or queue data packets buffered in memory 208. According to the present invention, scheduler 212 is configured to identify each packet, by its header, VLAN tag, etc., and schedule data packets for transmission at each port based upon the priority of the data packet, the bandwidth allotted to the destination port, the order in which the packet was received, and/or the type of data packet.

Device 200 also may include a number of interfaces for directly controlling the device. These interfaces may provide for remote access (e.g., via a network) or local access (e.g., via a panel or keyboard). Accordingly, device 200 may include external interface ports, such as a USB or serial port, for connecting to external devices, or CPU 210 may be communicated with via network ports 202. In this example, interfaces are shown connected to device 200 via the CPU 210.

One having ordinary skill in the art will readily understand that many types of network devices may be used to implement the present invention. A more detailed example of an exemplary switch is shown and described in U.S. Pat. No. 6,104,696, which is hereby incorporated by reference. It should be noted that the switch described in the '696 patent is a specific switch implementation to which the present invention is not meant to be limited. One having ordinary skill in the art will readily understand that the present invention is applicable to many other switch and device configurations.

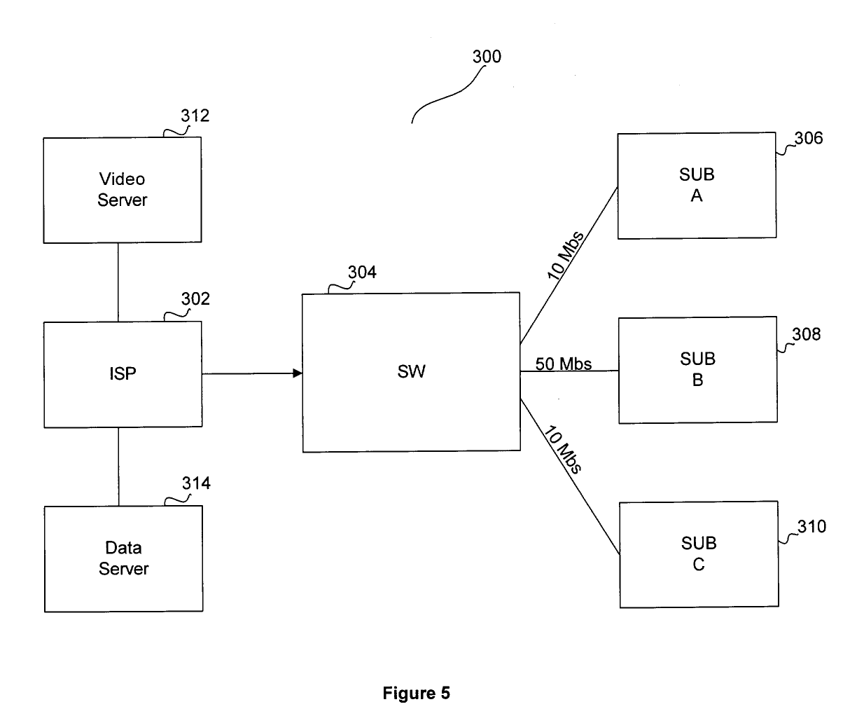

FIG. 5 shows another block diagram of a network, which is used to describe operational aspects of the present invention. Network 300 includes a plurality of subscribers 306-310 each connected to a switch 304. The subscribers 306-310 may also be considered as clients of the switch. Switch 304 may be connected to the Internet via an ISP network 302. ISP 302 may be connected to a number of servers via the Internet or another network, such as to a video server 312 and data server 314. In this embodiment, it is shown that subscribers 306 and 310 each are restricted to data at a rate of 10 Mbps. Subscriber B 308 is allocated data at a rate of 50 Mbps. These rates may be due to differing SLA's, or other reasons. Accordingly, subscriber B 308 would be allowed 5 times as many tokens as clients 306 and 310 if rate control is performed via the leaky bucket method. As described above, bandwidth may be allocated via the “leaky bucket” method or by other methods, but can also be modified as described below.

The present invention may be described in terms of a number of operational examples. Take the case where subscriber A 306 wants to connect to data server 314 to download music. Subscriber A 306 may navigate, such as through a browser, to a website to download content such as music. An Ethernet connection may be made to switch 304, which routes the connection through the ISP 302 to data server 314 to request the download. Then the download is initiated, and a stream of data packets are routed back to subscriber A 306 through switch 304. Subscriber A 306 has a SLA with the ISP that limits its bandwidth to 10 Mbps. Accordingly, the download from data server 314 to subscriber A 306 may be at a rate of no more than 10 Mbps.

As data is routed from ISP 302 to subscriber A 306 via switch 304, the ARL of switch 304 may allocate tokens based on the number and size of data packets during predetermined intervals. If the data exceeds 10 Mbps, then additional data packets over the limit are buffered and/or dropped.

Take the case where subscriber A may order a movie in, for example HDTV video format, which is downloaded from video server 312. When the data packets carrying the HDTV video are received at switch 304 for routing to subscriber A 306, the ARL of switch 304, which may be configured to “snoop” the ports of the switch, determines the type of data being routed. The type of data may be determined from the data packet itself or from a VLAN tag, which may be inserted by any device in the network. Once rate control is determined for a specific service, switch 304 may identify each packet based on the source address or other identifying fields. Therefore, data packets with a different source address or other differing fields may be treated separately.

For instance, a burst may be transmitted from a source (not shown) in order to transfer the data packets carrying the HDTV video to switch 304 for routing to subscriber A 306. Due to the rate control provisions imposed on the network device, switch 304 may not be able to process the packets at the same rate at which the packets are received at the input ports. Thus, the network device may store the packets in a buffer until the packets can be further processed. The burst may cause the buffer of switch 304 to approach its threshold. As the buffer fills, a method of selective early drop may be implemented to prevent congestion. Namely, the buffer's manager must decide from which port or queue to drop the incoming data packets in order to prevent the buffer from exceeding its storage area.

Furthermore, if conventional techniques are employed to carry out the packet dropping decision and if any incoming packets are received at switch 304, packets may be dropped because there is not enough storage space in the buffer. This decision would not be based upon service level. This is a disadvantage associated with the conventional techniques since these techniques may make their decision as to which packets to drop based primarily upon the bandwidth usage and not based upon the terms negotiated between the entities of the network. In other words, although one client, for example, subscriber B 308, may have negotiated with the SLA to pay more for its larger bandwidth, during a burst in which subscriber A 306 usurps all of the storage resources of the buffer, as described above, a conventional device may drop the packets intended for subscriber B 308 instead of another client, for example, subscriber A 306. Therefore, in order to maintain quality of service to each subscriber, a method of selective early drop may be implemented according to the invention.

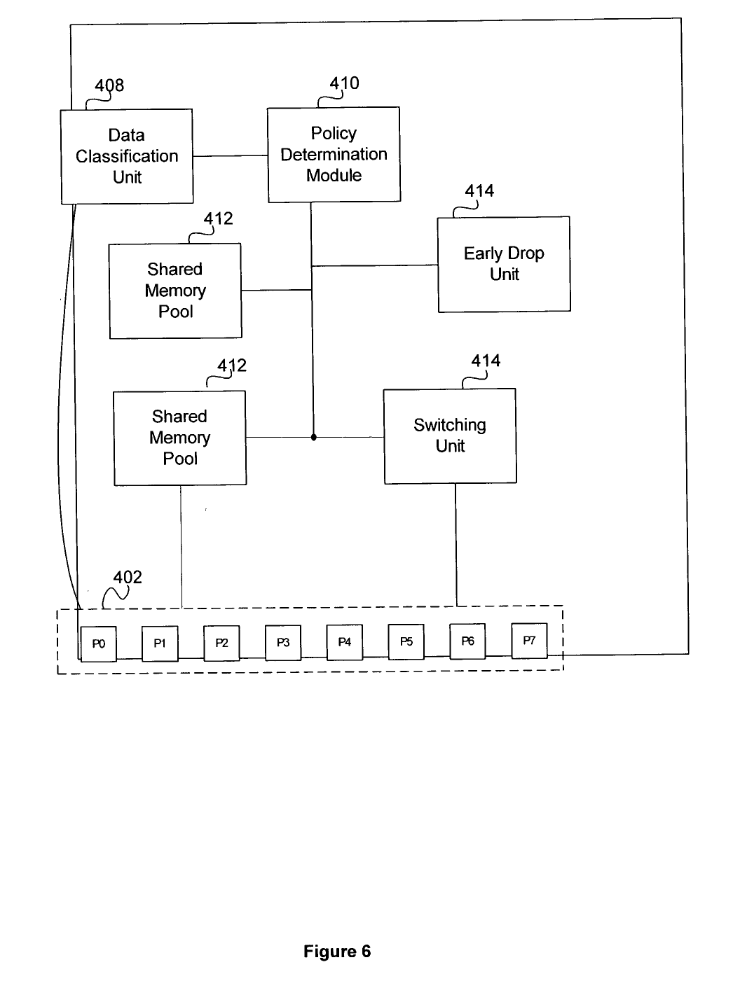

FIG. 6 is a block diagram of an exemplary network device according to an embodiment of the present invention. Network device 400 may be a switch, hub, repeater, or any other network device which may be configurable to perform the network functions defined herein. Device 400 includes plurality of network ports 402 which are configured to send and receive signals to other network devices over a network. Accordingly, port 402 may be well-known PHYs or transceivers. Device 400 may also include a packet forwarding unit 404, a rate control unit 406, a data classification unit 408, a policy determination module 410, a shared memory pool 412, and an early drop unit 414. Packet forwarding unit 404 is connected to ports 402 and is configured to perform various switching functions in relation to signals received at port 402. For example, if device 400 is a network switch, packet forwarding unit 404 may contain the necessary hardware and software in order to switch data packets from one port of ports 402 to another port. If on the other hand, that network device 400 is a repeater, packet forwarding unit 404 contains the necessary hardware and software in order to repeat a signal received at one port of ports 402 to all the ports 402.

Rate control unit 406 is coupled with ports 402 and packet forwarding unit 404, and is configured to perform rate control functions in relation to data packets which are received at ports 402 and being switched, repeated, networked, etc. by packet forwarding unit 404. For example, as described above, rate control may be performed in relation to data packets being switched to a particular subscriber in order to limit the bandwidth that the subscribers receive in connection with a subscribers SLA. Such rate control may be performed by the leaky bucket method or any other known rate control means. Rate control unit 406 may include any necessary hardware and software in order to perform rate control functions.

Data classification unit 408 is coupled with ports 402 and with policy determination module 410, and is configured to “snoop” data packets being received at any of ports 402. Data classification unit 408 is also configured to classify the type of data being received at each port and to transmit this classification to policy determination module 410. In response to the classification of any data packet received, policy determination module 410 is configured to determine the policy terms negotiated by the network entities in connection with each packet in the data stream. The policy determination module 410 may use one or more of the data classification tags as discussed above to serve as a policy term identification tag, which can be used to classify the data packet and determine the policy terms to be applied to the packet. Accordingly, the policy determination module 410 may be configured to include or communicate with a look-up table (not shown) in order to use the classification data as an identification tag to search the look-up table to determine the appropriate policy term for each data packet. If the policy determination module 410 cannot ascertain the policy term for a particular packet, the policy term determination module 410 may instruct the network device to send a policy term request to the source to establish the policy terms of the data packet, as described below.

As rate control is applied, and congestion occurs, data packets are buffered in the shared memory pool 412 and queue. As the buffer fills, the early drop unit 414 is configured to drop data packets ahead of queue. Accordingly, the early drop unit (or schedulers, which are not shown) is configured to identify information about each data packet in the queue and drop the data packet ahead of queue which is intended for a port. The early drop unit 414 may decide from which queue to drop data packets based upon the policy agreement established between two or more entities communicating over the network. The policy agreement may be established between, for example, a client and an ISP on the network, as shown in FIG. 3. The policy terms negotiated by the parties may be governed by a written contract such as a SLA. Alternatively or conjunctively, all or some of the policy terms may be negotiated dynamically between the network entities during the transmission of the data packets over the network. For instance, the ISP may be configured so that at least two or more network entities may compete or bid for the services of the ISP while simultaneously communicating over the network. The policy determination module 410 may also be coupled to and communicate with a CPU, which may use a packet-dropping algorithm to calculate the financial impact that one or more of the policy terms may impose upon the network. Data classification unit 408, policy determination module 410 and early drop unit 414 may individually or collectively each perform the function of serving as a service differentiation module to regulate the storage of the data packets in memory pool 412 based upon a comparison of the economic consequences of the terms negotiated between the network entities.

If policy determination module 410 cannot determine the policy terms for a particular data packet, the network device 400 may transmit a policy term request to the source connection to dynamically negotiate the assignment of a policy term for the packet. Accordingly, policy determination module 410 may be coupled to both data classification unit 408 and early drop unit 414 and configured to communicate with data classification unit 408 and early drop unit 414. Policy determination module 410 may determine that a packet lacks a policy term identification tag, and communicates with the data classification unit 408 to send a policy term request to the source via ports 402. Another feature of this embodiment of the invention is that the source connection may also transmit a signal to overwrite an existing policy term stored in the look-up table with a new policy term for a packet or for a particular class of packets.

In determining which packets to drop, policy determination module 410 and early drop unit 414 may rely upon one or more policy terms to differentiate between the types of services to be applied to the incoming packets. The policy terms may include, for example, the payment or fee arrangement term, window of performance, the type of business, uptime guarantee, penalty/remedy provisions, resource utilization and network utilization clauses. These policy terms are merely examples and the scope of the invention is not limited to these examples.

The payment or fee arrangement terms define the payment for the services either rendered by or rendered to the parties of the agreement. If subscriber B 308 has agreed to pay more for the cost of its services than subscriber A 306, policy determination module 410 may decide to analyze the payment structure between the clients and instruct the early drop unit 414 to drop the lower paying subscriber A 306. The window of performance and the type of business for each client are factors that may be analyzed in determining which data packets to drop. Policy determination module 410 may examine the fees negotiated by each client to be paid during different times, such as normal business hours and non-business hours. The policy determination module 410 may, for example, determine that the hours of 10:00 a.m. 4:00 p.m., Monday through Fridays are peak operating hours for a client, for example, who may be a stockbroker, to be connected to the stock market, and that the weekend hours are prime operating hours for, for example, professional sporting activities. Therefore, to ensure the network's uptime during these peak hours, the stockbroker may have negotiated to pay a higher price than the other network clients, and the professional sports organization may have agreed to pay higher fees during the weekend. However, the weekend hours may not be a critical time of performance for the stockbroker. Thus, the stockbroker may have negotiated a cheaper rate during these non-peak hours. Therefore, should a congestion problem threaten to occur, during the weekdays, the sports organization packets may be dropped and, during the weekend, the stockbroker's packets may be dropped.

The uptime guarantee may define the percentage of time that the ISP guarantees to the client that all network equipment, operating systems and supported software will be functioning and available to render services to the client. Furthermore, the parties' agreement may define the penalties either in additional services or credits, which will be imposed when one of the parties fails to perform according to the terms of the agreement. In other words, the policy terms may define the number of credits that a client will earn if the client's uptime received from the SLA is less than the uptime guarantee. For example, the agreement between subscriber A 306 and the ISP may state that if the availability of the ISP is 99%-99.9%, then subscriber A 306 may receive a 10% credit. The agreement between subscriber B 308 and the ISP may state that subscriber B 308 may receive a 25% credit if the availability of the ISP is 99%-99.9%. In making a policy decision as to which packets to drop, policy determination module 410 may determine that it would be more cost effective to drop pockets destined for subscriber B 308 than subscriber A 306.

Another policy term that may influence the early drop decision is the response time negotiated between the ISP and each client. The response time may indicate the elapsed time, which is acceptable between a request and a response transmitted between the parties. If the acceptable response time for one client has a longer time period without the ISP incurring any penalties, then the early drop decision may be based upon the response time. The throughput expenditure, which is the cost for the amount of data that can be transmitted from one location to another in a given period of time, may be another policy term negotiated by the parties. The agreement may also list the resources that each party may attach to the network, i.e., network utilization. Namely, each client may negotiate with the ISP to pay a specific amount to have a certain number of devices attached to the network. If a congestion problem threatens to occur, policy determination module 410 may consider the number of resources and the fee for the resources that each client has agreed to pay for. The policy determination module 410 may also analyze the resource utilization that each client has agreed to pay for. An analysis of the resource utilization may include the amount of bandwidth allotted for use by each of the clients.

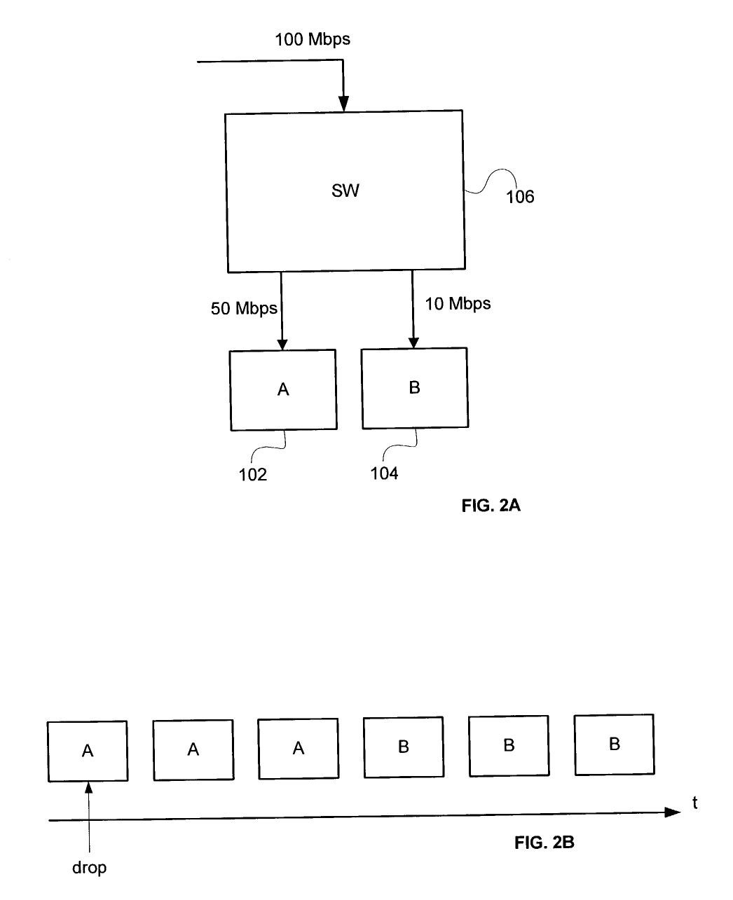

FIG. 6 is an exemplary block diagram of a network device in accordance with an embodiment of the present invention. One having ordinary skill in the art would readily understand that packet forwarding unit 404, rate control unit 406, data classification unit 408, policy determination module 410, and early drop unit 414 may be separate circuits or discrete components, or instead may be logical sub systems within a single chip or integrated circuit (IC). For example, referring to FIG. 2, ARL 206, MAC 204, CPU 210, and schedule 212 may individually or collectively each perform the functions of packet forwarding unit 404, rate control unit 406, data classification unit 408, policy determination module 410, and early drop unit 414. It should also be understood that the present invention is not meant to be limited to the exemplary configurations shown and described with reference to the drawing figures. Accordingly, the present invention may be applied to other network devices and configurations.

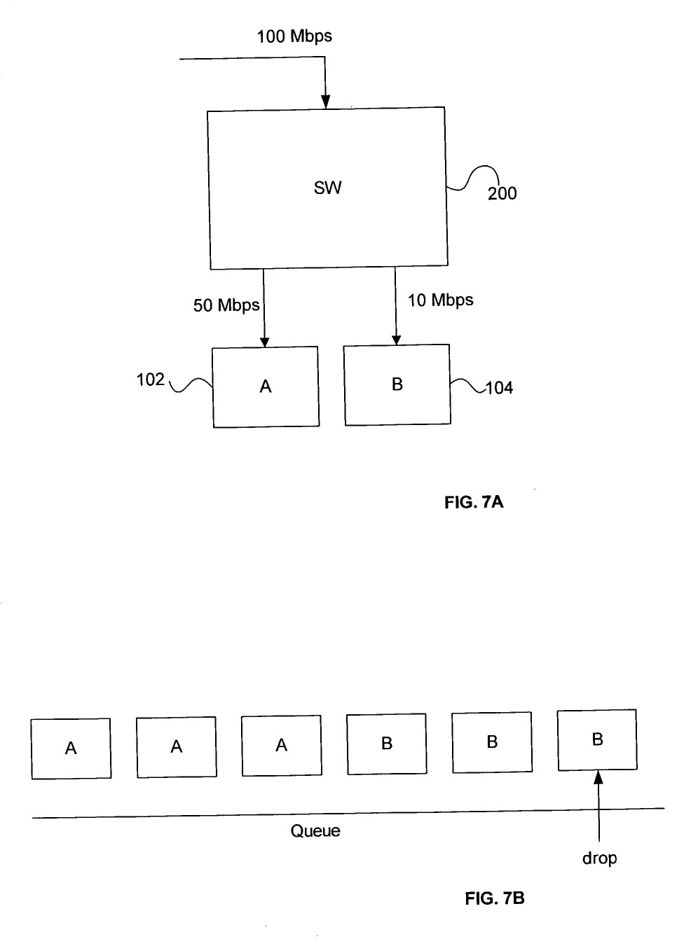

FIGS. 7A and 7B show a block diagram of a partial network and a graph of packet flow in the partial network, according to an embodiment of the present invention. A switch 200 connects clients 102 (subscriber A) and 104 (subscriber B) to a network, such as the Internet. In a network, bandwidth may be sold by the slice. In this case, subscriber A 102 is provided a connection at a speed of 10 Mbps while subscriber B 104 gets data at a speed of 50 Mbps. These rates may be guaranteed under an SLA, and enforced via a rate control device, such as that described above.

Switch 200 is shown in this example as a 100 Mbps switch. Accordingly, there is a significant speed mismatch between switch 200 and subscriber B 104. If bursts of traffic were directed to subscriber B 104, then switch 200 would need a large memory to buffer packets before they are sent. Furthermore, as packets are buffered before they are sent, switch 200 must have a large enough buffer so that subscriber B 104 will get its total bandwidth. For example, FIG. 7B shows packets being received at switch 200 to be routed to subscribers A and B. If the buffer of switch 200 is only large enough to hold five packets, then in this case, a packet must be dropped. Since it is desired that subscriber A 102 receives the full bandwidth, the packets destined for subscriber B 104 are dropped first, ahead of queue. Therefore, an early packet discard algorithm may be implemented to drop selected packets ahead of queue. Note that packets are preferably dropped based on the policy of the switch and not simply based on congestion. In other words, early drop may be performed based on the priority of the subscriber according to the policy terms negotiated by each subscriber. For example, subscriber A may be given a higher priority than subscriber B. Therefore, the packets destined for subscriber B are dropped before the packets destined for subscriber A.

Referring to FIG. 4, scheduler 212 may be configured to communicate with memory 208 and receive information about each packet in the queue. Scheduler 212 may then, based upon the utilization of memory 208, drop data packets based upon the policy terms. Accordingly, when memory 208 reaches a certain level, based upon the size of memory 208 and the policy terms for the packets stored in memory 208, packets may be dropped ahead of queue before the packets can be further processed by device 200. Also, scheduler 212 may also be configured to receive certain switching information from ARL 206 and to drop packets ahead of queue based upon the destination address, the destination port, the data rate of the destination port, or based upon an SLA of the subscriber connected to the destination port. SLA information may be programmed via CPU 210.

The determination of when to drop a packet may be made using a watermark method, which is based on the size of packets and the size of the shared memory pool. Generally, memory 208 inside device 200 may have a high watermark and a low watermark. Associated with these watermarks may be certain PAUSE times, during which the congestion is expected to ease. Upon exceeding the low-watermark, device 200 may generate a flow control frame with a PAUSE time. The PAUSE frame may be sent from device 200 to the source, which will then stop sending new packets for a time period specified by the PAUSE frame. After the PAUSE time has elapsed the source may resume sending packets again to device 200. If the congestion is not relieved, the packets in memory 208 may reach the high watermark. At this point, device 200 may send a PAUSE frame with a pause time higher than that associated with the low watermark. If the congestion does not ease during the PAUSE time, device 200 may begin to drop packets based upon the policy terms of the packets.

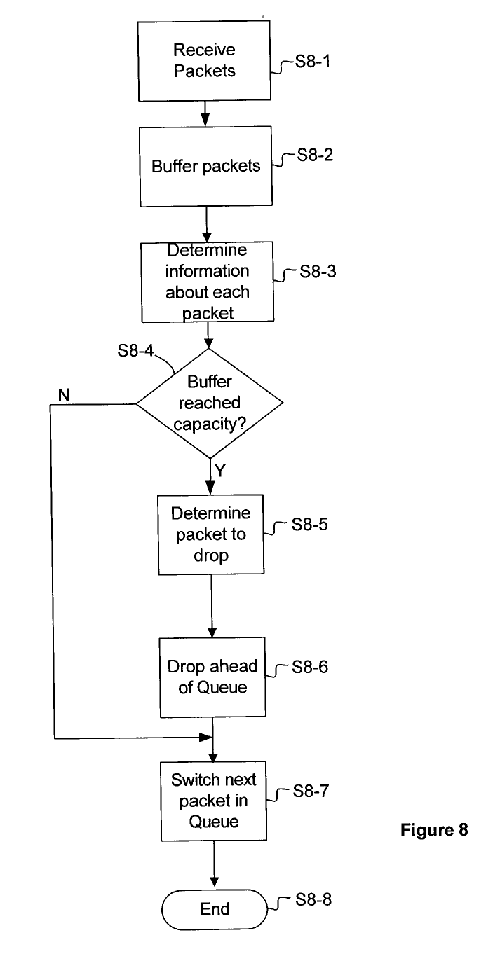

FIG. 8 is a flow chart of a method for selective early drop according to an embodiment of the present invention. At step S8-1, a packet is received at a device performing rate control, such as a network switch described above. The packet may be destined for a subscriber of an ISP, for example, and rate control may be applied to control the traffic to that subscriber. As described above, rate control may be applied a number of ways, such as by the leaky bucket method, and may be in accordance with an SLA.

Next, at step S8-2, the packet is buffered in a shared memory pool of the network device and placed into a queue. As described above, the device may include a scheduler which is coupled to the shared memory pool and configured to schedule the data packets stored for transmission. The scheduler may be configured to schedule the data packets based on type, destination address, destination port, or based on an SLA.

At step S8-3, information may be determined about each data packet in the shared memory pool, such as type of data, destination address, source address, etc. For example, as already described above, the port of a switch or other network device may be snooped by the ARL of the switch, the header of the packet may be read to determine the type of data, and the scheduler may communicate with the ARL or shared memory pool.

Next, at step S8-4, the capacity of the shared memory pool is checked. This can be accomplished by watermark technology or buffer-capacity detection scheme. If a predetermined level, based upon the size of the memory pool, size of the data packets, etc., is reached, then at step S8-5, the policy terms of the subscribers are checked to determine from which port a packet may be dropped ahead of queue at step S8-6, as described above. If not, then the packets are switched as normal by the scheduler in conjunction with the ARL at step S8-7. After a packet is dropped, packet switching also continues at step S8-7. Processing ends at step S8-8.

One having ordinary skill in the art will readily understand that the steps of the method may be performed in different order, or with multiple steps in parallel with one another. Also, one having ordinary skill in the art will understand that a network device may be configured to perform the above-described method either in silicon or in software. Accordingly, one will understand that the switching configurations described herein are merely exemplary. Accordingly, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A network device comprising:
a plurality of ports configured to send and receive data packets, wherein at least one port of the plurality of ports is connected to at least one network entity;
a memory pool configured to store the data packets; and
a service differentiation module coupled with the memory pool and configured to regulate storage of the data packets in the memory pool, said service differentiation module being configured to regulate based upon a comparison of terms negotiated between at least two network entities.

2. The network device according to claim 1, wherein the service differentiation module is configured to compare the terms negotiated between the at least two network entities based upon service levels.

3. The network device according to claim 2, wherein the service differentiation module is configured to compare the terms negotiated between the at least two network entities based upon a type of business.

4. The network device according to claim 2, wherein the service differentiation module is configured to compare the terms negotiated between the at least two network entities based upon a window of performance.

5. The network device according to claim 2, wherein the service differentiation module is configured to compare the terms negotiated between the at least two network entities based upon an uptime guarantee.

6. The network device according to claim 2, wherein the service differentiation module is configured to compare the terms negotiated between the at least two network entities based upon response time provisions.

7. The network device according to claim 2, wherein the service differentiation module is configured to compare the terms negotiated between the at least two network entities based upon throughput provisions.

8. The network device according to claim 2, wherein the service differentiation module is configured to compare the terms negotiated between the at least two network entities based upon resource utilization provisions.

9. The network device according to claim 2, wherein the service differentiation module is configured to compare the terms negotiated between the at least two network entities based upon network utilization provisions.

10. The network device according to claim 1, wherein the service differentiation module is configured to compare penalty provisions negotiated by the at least two network entities to regulate storage of the data packets.

11. The network device according to claim 10, wherein the service differentiation module is configured to compare the penalty provisions related to services to be performed by at least one of the at least two network entities.

12. The network device according to claim 10, wherein the service differentiation module is configured to compare the penalty provisions related to credits to be deducted by at least one of the at least two network entities.

13. The network device according to claim 1, wherein the service differentiation module is configured to compare remedy provisions to regulate storage of the data packets in the memory pool.

14. The network device according to claim 13, wherein the service differentiation module is configured to compare the remedy provisions related to services to be rendered to at least one of the at least two network entities.

15. The network device according to claim 13, wherein the service differentiation module is configured to compare the remedy provisions related to credits to be earned by at least one of the at least two network entities.

16. The network device according to claim 1, wherein the service differentiation module is configured to dynamically negotiate the terms between the at least two network entities.

17. The network device according to claim 16, wherein the service differentiation module is configured to permit the at least two network entities to perform real-time bidding to negotiate the terms.

18. The network device according to claim 1, wherein the service differentiation module is configured to permit the terms negotiated between the at least two network entities to be defined according to a service level agreement.

19. The network device as recited in claim 1, further comprising an early drop unit coupled with a scheduler and configured to drop data packets stored in said memory pool ahead of queue based on a current capacity of said memory pool.

20. The network device as recited in claim 19, wherein said early drop unit is configured to drop data packets stored in said memory pool ahead of queue based on service level agreements associated with the at least one network entity.

21. The network device as recited in claim 19, wherein said early drop unit is configured to drop data packets stored in said memory pool ahead of queue based on said terms negotiated dynamically between the at least two network entities.

22. The network device as recited in claim 1, wherein the service differentiation module is configured to regulate based upon a comparison of economic consequences of terms negotiated between at least two network entities.

23. A method of flow control in a network device, said method comprising:
providing a plurality of ports in a network device, wherein at least one port of the plurality of ports is connected to at least one network entity;
receiving a data packet at the at least one port of said plurality of ports; and
regulating storage of said packet in a memory buffer based upon terms negotiated between at least two network entities.

24. The method as recited in claim 23, further comprising the steps of:
determining a capacity level of said memory buffer; and
dropping a data packet stored in said memory buffer ahead of queue in said queue when said capacity reaches a predetermined level.

25. The method as recited in claim 24, wherein said step of dropping said data packet further comprises dropping said data packet stored in said memory buffer ahead of queue in said queue further based on comparing costs of services paid by the at least two network entities.

26. The method as recited in claim 24, wherein said dropping step includes comparing penalty provisions negotiated between the at least two network entities.

27. The method as recited in claim 24, wherein said dropping step includes comparing remedy provisions negotiated between the at least two network entities.

28. The method as recited in claim 23, further comprising the step of dynamically negotiating the terms between the at least two network entities.

29. The method as recited in claim 28, wherein the step of dynamically negotiating further comprises real-time bidding of the terms between the at least two network entities.

30. The method as recited in claim 23, further comprising the step of defining the terms according to a service level agreement negotiated between the at least network entities.

31. The method as recited in claim 23, wherein said regulating is based upon a comparison of economic consequences of terms negotiated between at least two network entities.

32. A network device comprising:
a plurality of ports configured to send and receive data packets, wherein at least one port of the plurality of ports is connected to at least one network entity connected to the network device;
a memory pool means for storing data packets; and
a service differentiation means for regulating storage of said data packet in a memory buffer based upon terms negotiated between at least two network entities.

33. The network device as recited in claim 32, wherein the service differentiation means is configured to compare the terms negotiated between the at least two network entities based upon service levels.

34. The network device as recited in claim 32, wherein the service differentiation means is configured to compare penalty provisions negotiated between the at least two network entities to regulate storage of the data packets in the memory pool means.

35. The network device as recited in claim 32, wherein the service differentiation means is configured to compare remedy provisions negotiated between the at least two network entities to regulate storage of the data packets in the memory pool means.

36. The network device as recited in claim 32, wherein the service differentiation means is configured to dynamically negotiate the terms between the at least two network entities.

37. The network device as recited in claim 32, wherein the service differentiation means is configured to permit the terms negotiated between the at least two network entities to be defined according to a service level agreement.

38. The network device as recited in claim 32, wherein the service differentiation means is configured to regulate based upon a comparison of economic consequences of terms negotiated between at least two network entities.

39. The network device as recited in claim 1, wherein the network device comprises a switch.

40. The network device as recited in claim 1, wherein the network device comprises a router.

41. The network device as recited in claim 1, wherein the network device comprises a repeater.
